(19) United States
(12) Patent Application Publication
(10) Pub. No.: US 2005/0123311 A1
(43) Pub. Date: Jun. 9, 2005

(54) Image forming apparatus and method for sensing remaining amount of developer

(75) Inventors: Young-Min Kim, Suwon-si (KR); Sung-Gi Kim, Yongin-si (KR); Sang-Cheol Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/002,095

(22) Filed: Dec. 3, 2004

(30) Foreign Application Priority Data
Dec. 6, 2003 (KR) 2003-88416
Feb. 19, 2004 (KR) 2004-11006

(51) Int. Cl. G03G 15/08

(52) U.S. Cl. 399/27

(57) ABSTRACT

An image forming apparatus and method are disclosed. The image forming apparatus comprises a photosensitive medium being formed an electrostatic latent image thereon; a developing roller developing a developer to the photosensitive drum being formed an electrostatic latent image; and a remnant developer sensing device sensing an electrical value between the developing roller and the photosensitive medium and determining the remaining amount of the developer of the developing device.

### CROSS-REFERENCE TO RELATED APPLICATIONS

This application claims the benefit under 35 U.S.C. §119(a) of Korean Patent Application No. 2003-88416, filed on Dec. 6, 2003 and No. 2004-11006, filed on Feb. 19, 2004, in the Korean Intellectual Property Office, the entire disclosures of each are incorporated herein by reference.

### BACKGROUND OF THE INVENTION

1. Field of the Invention

The present invention relates to an image forming apparatus and method for sensing the amount of remaining developer. More particularly, the present invention relates to an image forming apparatus having a developer sensing device for sensing an amount of remnant developer in a development cartridge.

2. Description of the Related Art

In a general image forming apparatus, a toner, as a developer, is supplied to an electrostatic latent image formed on a surface of the photosensitive medium by an exposing unit to make the electrostatic latent image into a toner image. The toner image is transferred and fused to a printing medium such that a desired image is printed.

The developer is stored in a developer loading unit. A printing operation can be smoothly performed before the developer is exhausted by continuously supplying it to the developer loading unit. Therefore, a developer sensing device is required for checking the remaining amount of developer stored in the developer loading unit.

FIG. 1 is a view illustrating the construction of a developing device having a conventional remnant developer sensing device. Referring to FIG. 1, a photosensitive drum 16 for rotating at a constant speed is installed within a housing 11. In order to charge the photosensitive drum 16 at a high voltage, a charging roller 17 is installed on one surface of the photosensitive drum 16. An exposing unit 20 for exposing a constant image to the photosensitive drum 16 charged by the charging roller 17 is installed at one side of the photosensitive drum 16. A developing roller 15 for supplying the toner to form the electrostatic latent image formed on a surface of the photosensitive drum 16 into the toner image is installed to be in contact with the surface of the photosensitive drum 16.

A toner loading unit 12 for storing the toner (the developer) is installed within the housing 11. An agitator 13 for agitating to prevent the toner from hardening is installed at a lower side of the toner loading unit 12. A supplying roller 14 for supplying the toner stored in the toner loading unit 12 to the developing roller 15 is installed to be rotated in contact with the developing roller 15.

A regulation blade 20 for regulating a thickness of the toner attached to a surface of the developing roller 15 is installed on one surface of the developing roller 15. A cleaning blade 18 for cleaning the toner remaining after the toner image is transferred to a paper is installed on one surface of the photosensitive drum 16. The toner cleaned by the cleaning blade 18 is temporarily housed in a waste-toner storing unit 19 and then is recovered by a recovery unit (not shown) for reuse.

As the remnant developer sensing device, a pressure sensor 30 is installed at a lower side of the toner loading unit 12. The pressure sensor 30 senses a weight of the developer in the toner loading unit 12, and provides a constant vibration and an electrical signal to recognize a difference between an input value and an output value and compares the input value with the output value to sense the remaining amount of the developer.

A photo sensor is used in another method for sensing the remaining amount of the developer by using a photo sensor. In this method, a light emitting unit and a light receiving unit are installed facing with each other at both sides of the toner loading unit, and how much light radiated from the light emitting unit is received by the light receiving unit is measured to sense the amount of the toner remaining in the toner loading unit. In other words, if the light radiated from the light emitting unit is not transmitted to the light receiving unit, it means that the toner is sufficient. However, if the light radiated from the light emitting unit is transmitted to the light receiving unit, it means that the toner is almost exhausted.

Further, a pixel counter or a dot counter is used in another method. In this method, a dot number of real printed data is calculated, thereby calculating an amount of used developer using a constant operational formula.

However, in a method for sensing the remaining amount of the developer by using a pressure sensor, there is a limit in the pressure sensors ability to exactly measure how much of the developer remains.

Further, in the method for sensing the remaining amount of developer using a photo sensor, the photo sensor is limited in exactly measuring the remaining amount of developer because the amount of developer can be erroneously sensed as being sufficient even when the light radiated from the light emitting unit is cut off and not received at the light receiving unit due to a concentration of the developer at a specific position in the toner loading unit.

Additionally, in the method for sensing the remaining amount of the developer using a pixel counter, it is a difficult to exactly calculate the exhaustion time of the developer since variables necessary in printing operation such as the printing environment, the printing resolution, the print density, and the like influence the operational formula.

### SUMMARY OF THE INVENTION

The present invention provides an image forming apparatus having a remnant developer sensing device for exactly sensing the exhaustion time of a developer to allow a smooth image forming operation.

According to an aspect of the present invention, there is provided an image forming apparatus comprising a photosensitive medium being formed an electrostatic latent image thereon; a developing roller developing a developer to the photosensitive drum being formed an electrostatic latent image; and a remnant developer sensing device sensing an electrical value between the developing roller and the photosensitive medium and determining the remaining amount of the developer of the developing device. The remnant developer sensing device sensing also compares the sensed value with a reference value to determine a remaining amount of the developer.

According to another aspect of the present invention, there is provided an image forming apparatus comprising a photosensitive medium being formed a latent image thereon; a developing roller developing a developer to the photosensitive drum being formed an electrostatic latent image; a sensing unit measuring an electrical value between the developing roller and the photosensitive medium; and a remnant developer sensing device including a pixel counter measuring the number of pixels of an image formed on a paper and calculating an amount of toner used to form the image, to sense a remaining amount of toner in a toner loading unit.

According to another aspect of the present invention, there is provided a method for determining the amount of remaining toner in an image forming apparatus comprising the steps of being formed a latent image on a photosensitive medium; developing a developer on the photosensitive drum being formed an electrostatic latent image; measuring an electrical value between the developing roller and the photosensitive medium; and determining the remaining amount of the developer of the developing device. In addition, the method also comprises the step of comparing the measured electrical value with a reference value to inform a user whether or not developer remains.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a construction of a developing device having a conventional remnant developer sensing device;

FIG. 2 is a view illustrating a schematic construction of an image forming apparatus having a remnant developer sensing device according to an embodiment of the present invention;

FIG. 3 is a view illustrating a construction of a remnant developer sensing device according to an embodiment of the present invention; and

FIG. 4 is a view illustrating an operation of a remnant developer sensing device in case where a developer is sufficiently developed between a photosensitive medium and a developing roller according to one embodiment of the present invention;

FIG. 5 is a view illustrating an operation of a remnant developer sensing device in case where a developer is not developed from a developing roller to a photosensitive medium according to an embodiment of the present invention;

FIG. 6 is a view illustrating an operation of a remnant developer sensing device in case where a developer is insufficiently developed from a developing roller to a photosensitive medium according to an embodiment of the present invention;

FIG. 7 is a view illustrating an operation of a remnant developer sensing device in case where a developing roller and a photosensitive medium are in contact with each other according to an embodiment of the present invention;

FIG. 8 is a view illustrating a construction of a remnant developer sensing device according to another embodiment of the present invention;

FIG. 9 is a view illustrating an operation of a remnant developer sensing device in case where a developer is sufficiently developed between a photosensitive medium and a developing roller according to another embodiment of the present invention;

FIG. 10 is a view illustrating an operation of a remnant developer sensing device in case where a developer is not transferred from a developing roller to a photosensitive medium according to another embodiment of the present invention;

FIG. 11 is a view illustrating an operation of a remnant developer sensing device in case where a developer is insufficiently developed from a developing roller to a photosensitive medium according to another embodiment of the present invention; and

FIG. 12 is a view illustrating an operation of a remnant developer sensing device in the case where a developing roller and a photosensitive medium are in contact with each other according to another embodiment of the present invention.

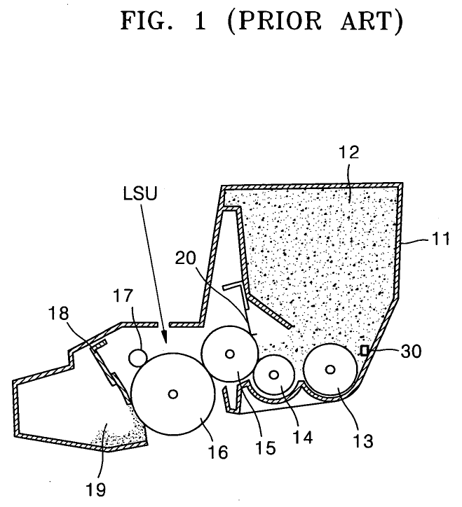

### DETAILED DESCRIPTION OF THE EXEMPLARY EMBODIMENTS

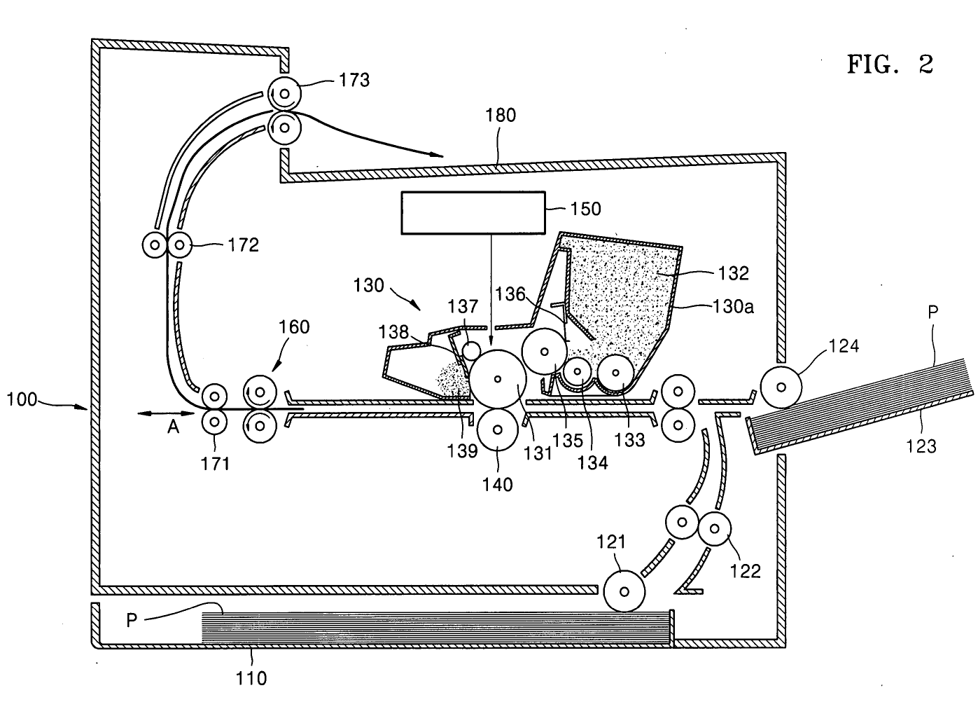

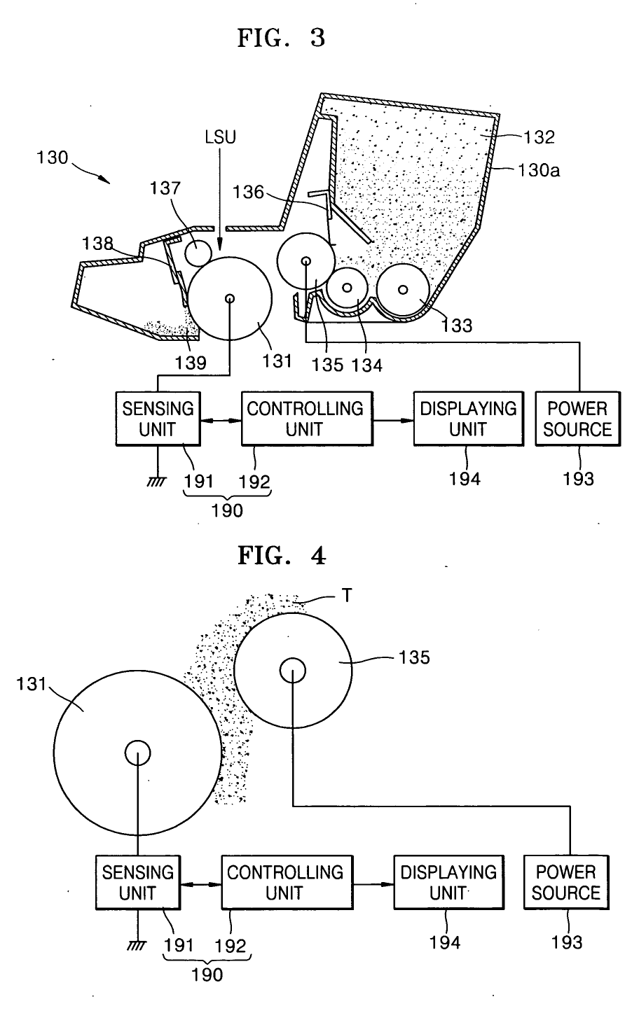

FIG. 2 is a schematic view illustrating a construction of an image forming apparatus having a remnant developer sensing device according to one embodiment of the present invention, and FIG. 3 is a view illustrating a construction of the remnant developer sensing device according to one embodiment of the present invention.

Referring to FIGS. 2 and 3, a paper cassette 110 for storing a paper (P) is detachably installed at a lower portion of a body 100, and a multi-purpose paper feeding tray 123 for loading the paper (P) is installed at a side portion of the body 100. Pickup rollers 121 and 124 for picking up the loaded paper (P) sheet by sheet are respectively installed at upper sides of the cassette 110 and the multi-purpose paper feeding tray 123.

A developing unit 130 for developing an image and a transferring unit 140 for transferring the image developed by the developing unit 130 to the paper (P) are installed along a transport path through which the paper picked-up by the pickup rollers 121 and 124 is transported by a transport roller 122.

The developing unit 130 is surrounded by a housing 130a. A photosensitive medium 131 on the surface of which an electrostatic latent image is formed by an exposing unit 150 is installed within the housing 130a to be faced with the transferring unit 140 with the transported paper being interposed therebetween.

The developing unit 130 comprises a developer loading unit 132 for storing a toner (developer); an agitator 133 installed at a lower portion of the developer loading unit 132 to agitate the toner to prevent the developer housed in the developer loading unit 132 from being hardened; a developing roller 135 installed to be at a distance from the photosensitive medium 131 to supply the developer to the electrostatic latent image formed on the surface of the photosensitive medium 131; and a supplying roller 134 installed to be rotated in contact with the developing roller 135 to supply the developer loaded on the developer loading unit 132 to the developing roller 135.

Further, the developing unit 130 includes a regulation blade 136 for regulating the thickness of the developer attached to the surface of the developing roller 135 by the supplying roller 134; and a cleaning blade 138 for cleaning the remaining toner not transferred from the photosensitive medium 131 to the paper (P). Waste-toner cleaned by the cleaning blade 138 is stored in a waste-toner storing unit 139 and then is recovered by a recovery unit (not shown).

The transferring unit 140 is installed to face and to be in contact with the photosensitive medium 131 to apply pressure on the paper (P) toward the photosensitive medium 131 such that a toner image formed on the photosensitive drum 131 is transferred to the paper (P).

The toner image transferred to the paper (P) by the transferring unit 140 is heated and pressurized through a fixing unit 160 installed at a paper path to be fused to the paper (P), and then the paper (P) is discharged to the exterior of the body 100 by discharging rollers 171 and 172 on a paper discharge tray 180.

The image forming apparatus includes the remnant developer sensing device 190 to sense an amount of the developer stored in the developer loading unit 132.

The remnant developer sensing device 190 comprises a sensing unit 191 installed to be electrically connected to the photosensitive medium 131 to measure an electrical value between the developing roller 135 and the photosensitive medium 131; and a controlling unit 192 for comparing the measured value of the sensing unit 191 and a predetermined reference value with each other to check whether the measured value between the developing roller 135 and the photosensitive medium 131 is less or more than the reference value such that the remaining amount of the developer housed in the developer loading unit 132 is sensed. The measured value of the sensing unit 191 and the predetermined reference value are stored in a memory unit (not shown).

The remnant developer sensing device 190 measures an electrical value between the developing roller 135 and the photosensitive medium 131 to sense the remaining amount of the developer housed in the developer loading unit 132.

The developer from the developing roller 135 is developed onto the photosensitive medium 131 by using a voltage difference between the developing roller 135 and the photosensitive medium 131. Therefore, in order to generate the voltage difference, the developing roller 135 is connected with a power source 193 to have a constant electric potential, and the photosensitive medium 131 is charged to a high potential by a charge roller 137 and a portion of the photosensitive medium 131 exposed using the exposing unit 150 has a varied potential to generate an electric potential difference with the developing roller 135. A direct current power source (DC), an alternating current power source or a combination of the direct current power source and the alternating current power source can be used as a power source 193 connected to the developing roller 135.

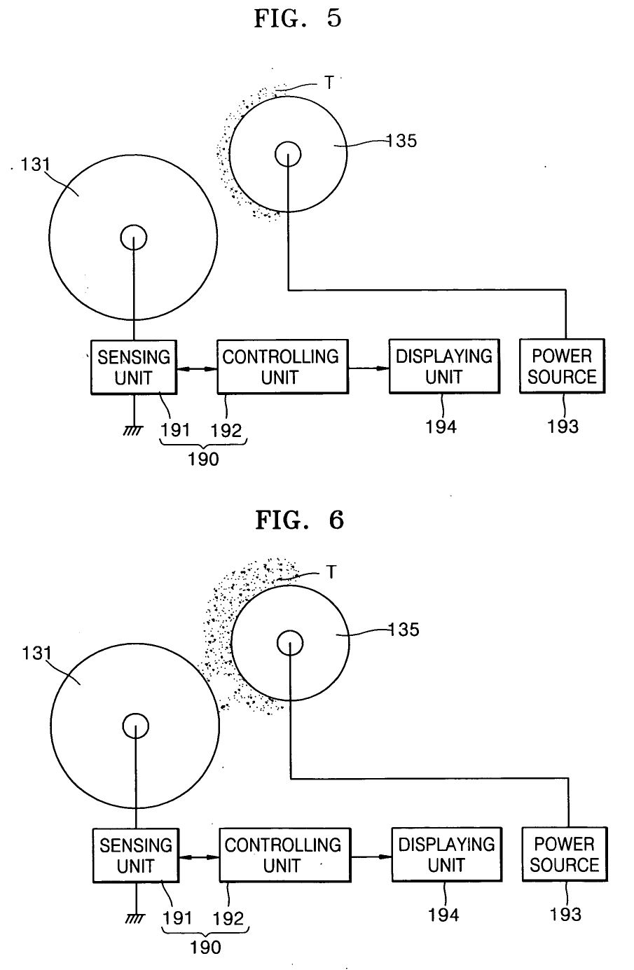

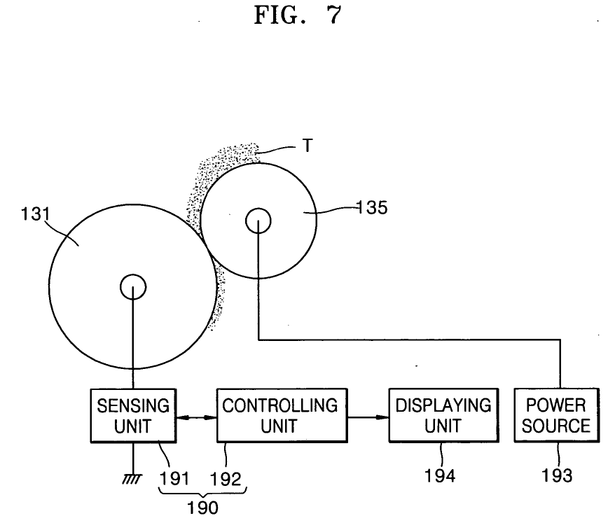

FIG. 4 is a view illustrating the operation of a remnant developer sensing device in the case where a developer is sufficiently developed between a photosensitive medium and a developing roller according to an embodiment of the present invention. FIG. 5 is a view illustrating an operation of a remnant developer sensing device in the case where a developer is not developed from a developing roller to a photosensitive medium according to one embodiment of the present invention. FIG. 6 is a view illustrating an operation of a remnant developer sensing device in the case where a developer is insufficiently developed from a developing roller to a photosensitive medium according to an embodiment of the present invention. FIG. 7 is a view illustrating an operation of a remnant developer sensing device in the case where a developing roller and a photosensitive medium are in contact with each other according to an embodiment of the present invention.

Referring to FIG. 4, while the developer is developed from the developing roller 135 to the photosensitive medium 131, the developing roller 135 and the photosensitive medium 131 are connected to each other by the toner (T). At this time, since the toner (T) is a conductive material, the photosensitive medium 131 is electrically connected with the developing roller 135. Since the developing roller 135 and the photosensitive medium 131 are grounded, a closed circuit is wholly constituted.

Accordingly, the sensing unit 191 can measure the electrical value between the developing roller 135 and the photosensitive medium 131. The electrical value measured by the sensing unit 191 between the developing roller 135 and the photosensitive medium 131 can be any one of a current value (I), a voltage value (V) or an electrostatic capacitance (C).

In the case where the sensing unit 191 is used to measure the current value (I) flowing between the developing roller 135 and the photosensitive medium 131, a current meter is installed to measure the current value (I) flowing between the developing roller 135 and the photosensitive medium 131. The current value flowing when the developer is normally developed from the developing roller 135 to the photosensitive medium 131 is previously measured and compared with the stored reference value. If it is identical with the reference value, it means that the developer loading unit 132 is filled with the developer.

As shown in FIG. 5, if due to an insufficient developer, the developer is attached only to the surface of the developing roller 135 and is not developed to the photosensitive medium 131, the developer is insufficiently loaded on the developer loading unit 132. At this time, the current does not flow between the developing roller 135 and the photosensitive medium 131, thereby causing the current value (I) measured by the sensing unit 191 to be approximately zero. Since this value is less than the reference value, it means that the developer loading unit 132 does not have a sufficient amount of the developer remaining to form a quality reproduction.

Further, even in the case where the developer partially connects the developing roller 135 with the photosensitive medium 131 as shown in FIG. 6, the current value (I) measured by the sensing unit 191 is less than in the case where the developer connects the developing roller 135 with the photosensitive medium 131 as shown in FIG. 4. Since the current value is less than the reference value, it means that the developer loading unit 132 does not have a sufficient of developer.

A reason for why the electrical value is measured between the developing roller 135 and the photosensitive medium 131 is to measure the remaining amount of developer loaded in the developer loading unit 132 as described above is as follows. The conventional remnant developer sensing devices quantitatively measure how much developer is loaded on the developer loading unit 132. Actually, an insufficient amount of developer is supplied, even though the developer loading unit 132 is filled with developer, to the developing roller 135. Therefore, the developer is not supplied with its normal amount of developer from the developing roller 135 to the photosensitive medium 131. Therefore, the toner image is not formed on the photosensitive medium 131.

Therefore, when the developer is normally supplied from the developing roller 135 to the photosensitive medium 131, the developer is sufficiently loaded on the developer loading unit 132. When the developer is abnormally supplied from the developing roller 135 to the photosensitive medium 131, the developer is insufficient or exhausted from the developer loading unit 132.

Referring to FIG. 7, a basic construction of the remnant developer sensing device 190 is the same as that of FIG. 3, but the toner is transferred from the developing roller 135 to the photosensitive medium 131 when the developing roller 135 is in contact with the photosensitive medium 131.

The electrical value measured by the sensing unit 191 between the developing roller 135 and the photosensitive medium 131 is a sum of an electrical value caused by a contact thereof and an electrical value caused by the developer while the developer passes between the developing roller 135 and the photosensitive medium 131.

Accordingly, if the amount of the developer passing between the developing roller 135 and the photosensitive medium 131 varies, the electrical value sensed by the sensing unit 191 is varied. This is used to sense the remaining amount of the developer.

The controlling unit 192 is connected with a displaying unit 194 to compare the measured value sensed by the sensing unit 191 with the reference value and display the comparative result such that a user can easily recognize the remaining amount of the developer loaded on the developer loading unit 132.

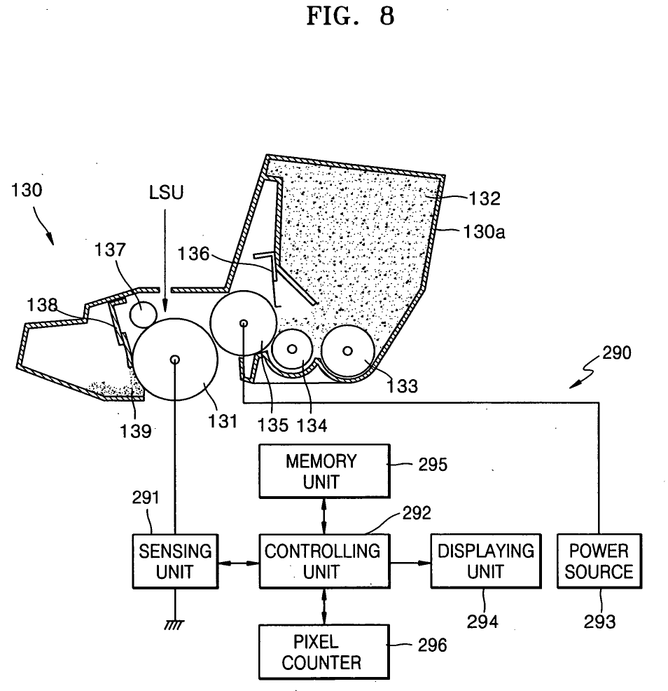

FIG. 8 is a view illustrating a construction of a remnant developer sensing device according to another embodiment of the present invention. The same reference numerals as those of FIG. 3 denote the same elements performing the same functions.

Referring to FIG. 8, the remnant developer sensing device 290 includes a sensing unit 291, which is an electrical sensor, for sensing an electrical value between a developing roller 135 and a photosensitive medium 131 and comparing the sensed value with a reference value to determine a remaining amount of toner; a pixel counter 296 for measuring the number of pixels of an image formed on a paper (P) and calculating a used amount of toner, to sense the remaining amount of toner in the toner loading unit 132; a memory unit 295 for storing the sensed value of the sensing unit 291 and the reference value, and storing a value of the sensed remaining amount of toner of the pixel counter 296 and a value of a fully loaded amount of the toner of the toner loading unit 132; a displaying unit 294 for informing the user of information on whether or not the toner remains; and a controlling unit 292 for performing general controls of the sensing unit 291, the pixel counter 296, the memory unit 295 and the displaying unit 294.

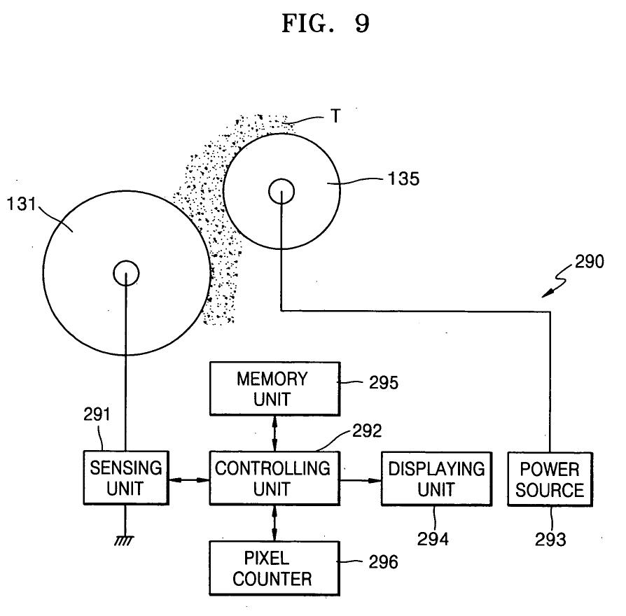

FIG. 9 is a view illustrating an operation of the remnant developer sensing device in the case where the developer is sufficiently developed between the photosensitive medium and the developing roller according to another embodiment of the present invention.

Referring to FIG. 9, while the toner is developed from the developing roller 135 to the photosensitive medium 131, the developing roller 135 and the photosensitive medium 131 are connected to each other by the toner (T). At this time, since the toner (T) is a conductive material, the photosensitive medium 131 is electrically connected with the developing roller 135. Since the developing roller 135 and the photosensitive medium 131 are grounded, a closed circuit is wholly constituted.

Accordingly, the sensing unit 291 can measure the electrical value between the developing roller 135 and the photosensitive medium 131. The electrical value measured by the sensing unit 191 between the developing roller 135 and the photosensitive medium 131 can be any one of a current value (I), a voltage value (V) or an electrostatic capacitance (C).

In the case where the sensing unit 191 is used to measure the current value (I) flowing between the developing roller 135 and the photosensitive medium 131, a current meter is installed to measure the current value (I) flowing between the developing roller 135 and the photosensitive medium 131. The current value, which flows when the developer is normally developed from the developing roller 135 to the photosensitive medium 131, is previously measured to compare the reference value stored in the memory unit 295 with the measured value measured in the sensing unit 291. If this measured value is identical with the reference value, it means that the toner is normally supplied to the developing roller 135. Therefore, the toner loading unit 132 is filled with the toner.

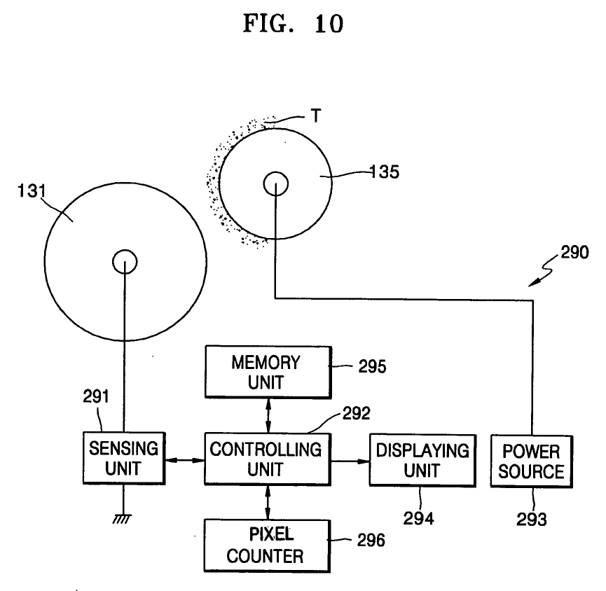

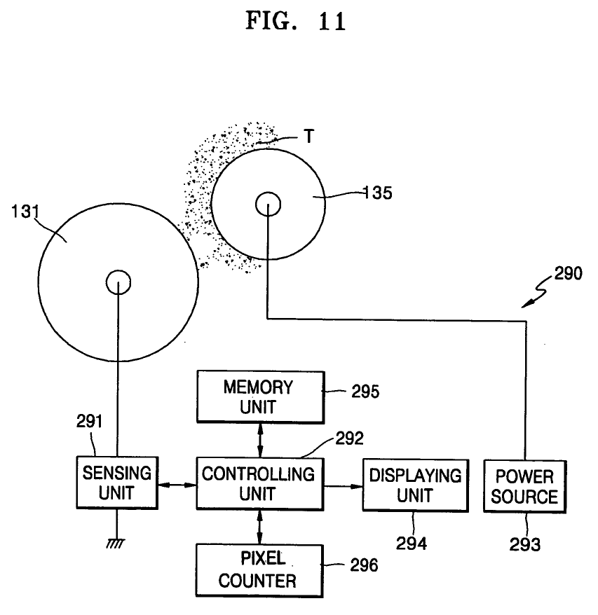

FIG. 10 is a view illustrating an operation of the remnant developer sensing device in the case where the developer is not developed from the developing roller to the photosensitive medium according to another embodiment of the present invention.

As shown in FIG. 10, if the toner is attached only to a surface of the developing roller 135 and is not developed onto the photosensitive medium 131 due to the insufficiency of the toner, the toner is insufficiently loaded on the toner loading unit 132. At this time, the current does not flow since the developing roller 135 is spaced apart from the photosensitive medium 131. Accordingly, the current value (I) measured by the sensing unit 291 is approximately zero. Since this value is less than the reference value, it means that the developer loading unit 132 does not have the remaining amount of the developer.

FIG. 11 is a view illustrating an operation of a remnant developer sensing device in the case where a developer is insufficiently developed from a developing roller to a photosensitive medium according to another embodiment of the present invention.

Further, even in the case where the developer partially connects the developing roller 135 with the photosensitive medium 131 as shown in FIG. 11, the current value (I) measured by the sensing unit 291 is less than in the case where the developer connects the developing roller 135 with the photosensitive medium 131 as shown in FIG. 4. Since the current value is less than the reference value, it means that the developer loading unit 132 does not have a sufficient amount of developer remaining to provide a quality reproduction.

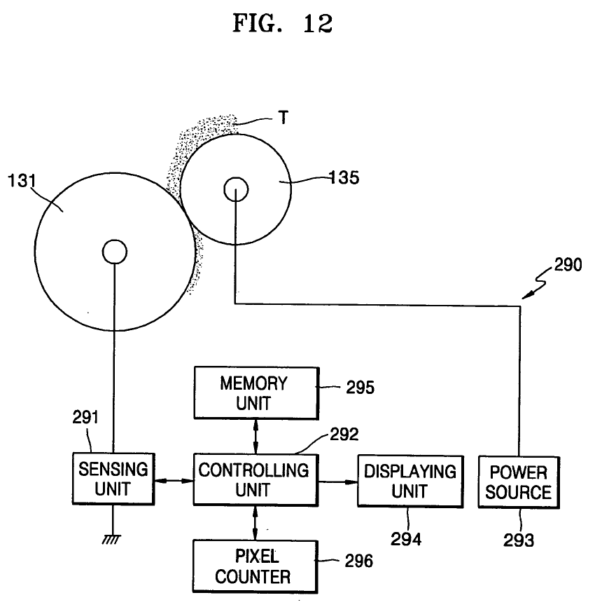

FIG. 12 is a view illustrating an operation of the remnant developer sensing device in the case where the developing roller and the photosensitive medium are in contact with each other according to another embodiment of the present invention.

Referring to FIG. 12, the toner is transferred from the developing roller 135 to the photosensitive medium 131 when the developing roller 135 is in contact with the photosensitive medium 131.

The electrical value measured by the sensing unit 291 between the developing roller 135 and the photosensitive medium 131 is a sum of an electrical value between the photosensitive medium 131 and the developing roller 135, which is caused by a contact therebetween, and an electrical value caused by the toner when the toner passes between the developing roller 135 and the photosensitive medium 131.

Accordingly, if the amount of the toner passing between the developing roller 135 and the photosensitive medium 131 varies, the electrical value sensed by the sensing unit 291 is varied. This is used to sense the remaining amount of the toner.

The controlling unit 292 is connected with a displaying unit 294 to compare the measured value sensed by the sensing unit 291 with the reference value stored in the memory unit 295 and inform the user with a message of “toner low or “toner empty” or other similar message. Accordingly, the user can easily recognize the remaining amount of the toner loaded on the developer loading unit 132.

Alternatively, the pixel counter 296 calculates the number of pixels or the number of dots printed on the paper by using a pixel counter or a dot counter to calculate an amount of the used toner by using a predetermined operation formula and store the calculate amount in the memory unit 295. Additionally, the controlling unit 292 compares the measured amount measured in the pixel counter 296 with an amount of an initial toner of the toner loading unit 231 to quantitively sense a remaining amount of toner.

The remaining amount of toner can-be displayed using a character or a specific symbol through a display panel, or indicated to the user through a lamp on a panel. Further, at a specific time point, usage information or information related to an amount of remaining developer can be output. Additional information can be provided by outputting corresponding information when the user presses a predetermined key.

The electrical sensing unit 291 and the pixel counting unit 296 are operated at the same time when a print signal is transmitted to the image forming apparatus, and they continuously measure the remaining amount of toner during the printing.

The below is an explanation of why the electrical value is measured between the photosensitive medium 131 and the developing roller 135 to measure the remaining amount of toner loaded on the toner loading unit 132 as described above.

Sometimes, the toner is not supplied in sufficient amounts even though the toner loading unit 132 is filled with toner because the toner is not supplied from the developing roller 135 to the photosensitive medium 131 in its normal fashion. Therefore, the toner image is not formed on the photosensitive medium 131.

Accordingly, when the toner is normally supplied from the developing roller 135 to the photosensitive medium 131, the toner is sufficiently loaded on the toner loading unit 132. When the toner is abnormally supplied from the developing roller 135 to the photosensitive medium 131, the toner is insufficient in the toner loading unit 132.

Further, it is required to quantitively measure how much of the toner remains in the toner loading unit 132. This can be realized using the pixel counting method.

As described above, the image forming apparatus according to the present invention has an effect in that an exhaustion time for the developer can be exactly recognized by measuring a variation of the electrical value depending on the toner amount provided between the developing roller and the photosensitive medium to detect the remaining amount of developer and at the same time, quantitively measuring the remaining amount of toner in the toner loading unit by using a pixel counter.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image forming apparatus comprising:
a photosensitive medium;
a developing roller for developing a developer to the photosensitive medium; and
a remnant developer sensing device for sensing an electrical value between the developing roller and the photosensitive medium and determining the remaining amount of the developer of the developing device.

2. The image forming apparatus of claim 1, wherein the remnant developer sensing device compares the sensed value to a reference value to determine a remaining amount of the developer.

3. The image forming apparatus of claim 1, wherein the remnant developer sensing device comprises:
a sensing unit for measuring the electrical value between the developing roller and the photosensitive medium; and
a controlling unit for comparing the measured value of the sensing unit with a reference value to determine the remaining amount of the developer.

4. The image forming apparatus of claim 3, wherein the sensing unit is electrically connected to the photosensitive medium.

5. The image forming apparatus of claim 3, wherein the electrical value is one of a current value, a voltage value, and an electrostatic capacitance.

6. The image forming apparatus of claim 3, further comprising a displaying unit comparing the measured value of the sensing unit with the reference value to inform a user whether or not the developer remains.

7. The image forming apparatus of claim 3, wherein the sensing unit is grounded.

8. The image forming apparatus of claim 1, wherein the electrical value between the developing roller and the photosensitive medium is detected according to the amount of the developer developed onto the photosensitive medium from the developing roller.

9. An image forming apparatus comprising:
a photosensitive medium;
a developing roller for developing a developer to the photosensitive medium;
a sensing unit for measuring an electrical value between the developing roller and the photosensitive medium; and
a remnant developer sensing device including a pixel counter for measuring the number of pixels of an image formed on a paper and calculating an amount of toner used to form the image, to sense a remaining amount of toner in a toner loading unit.

10. The image forming apparatus of claim 9, wherein the sensing unit is electrically connected to the photosensitive medium to measure the electrical value between the developing roller and the photosensitive medium.

11. The image forming apparatus of claim 10, wherein the developing roller is connected to a power source, and the sensing unit and the photosensitive medium electrically form a closed loop by the toner provided between the photosensitive medium and the developing roller.

12. The image forming apparatus of claim 9, wherein the electrical value is any one of a current value, a voltage value, and an electrostatic capacitance.

13. The image forming apparatus of claim 9, wherein the sensing unit is grounded.

14. The image forming apparatus of claim 9, further comprising a displaying unit comparing the measured electrical value of the sensing unit with a reference value to inform a user whether or not the developer remains.

15. The image forming apparatus of claim 9, wherein the electrical value between the developing roller and the photosensitive medium is detected according to the amount of the developer developed onto the photosensitive medium from the developing roller.

16. A method for determining the amount of remaining toner in an image forming apparatus comprising the steps of:
forming a latent image on a photosensitive medium;
developing a developer from a developing roller to the latent image on the photosensitive medium;
measuring an electrical value between the developing roller and the photosensitive medium; and
determining the remaining amount of the developer of the developing device.

17. The method of claim 16, wherein the electrical value between the developing roller and the photosensitive medium is detected according to the amount of the developer developed onto the photosensitive medium from the developing roller.

18. The method of claim 16, wherein the electrical value is any one of a current value, a voltage value, and an electrostatic capacitance.

19. The method of claim 16, further comprising the step of comparing the measured electrical value with a reference value to inform a user whether or not developer remains.
